(19) United States
(12) Patent Application Publication
(10) Pub. No.: US 2004/0187156 A1
(43) Pub. Date: Sep. 23, 2004

(54) Transporting home networking frame-based communication signals over coaxial cables

(76) Inventors: Stephen Palm, Irvine, CA (US); David Fifield, San Jose, CA (US)

Correspondence Address: James A. Harrison, P.O. Box 670007, Dallas, TX, 75367, US

(21) Appl. No.: 10/753,964

(22) Filed: Jan. 8, 2004

Related U.S. Application Data
(60) Provisional application No. 60/438,657, filed on Jan. 8, 2003.

(51) Int. Cl. H04N 7/173; H04N 7/16; H04N 7/18

(52) U.S. Cl. 725/81; 725/74; 725/131; 725/140

(57) ABSTRACT

A method and apparatus for coupling a system propagating wireless home networking communication signals to a system propagating television signals over a coaxial cable system to a device capable of receiving television signals that includes a three-port adapter having an antenna port, a first coaxial cable port and a second coaxial cable port. The antenna port is coupled to the system propagating home networking communications signals. The first coaxial cable port is coupled to the system propagating television signals over a coaxial cable. The second coaxial cable port is coupled to a device capable of receiving television signals.

### CROSS REFERENCE TO RELATED APPLICATIONS

This application claims priority to U.S. application Ser. No. 10/150,187 filed May 16, 2001, and to U.S. Provisional Application Serial No. 60/291,770, filed on May 17, 2001, and to U.S. Provisional Application Serial No. 60/438,657, filed on Jan. 8, 2003, which Utility and Provisional Applications are incorporated herein by reference in their entirety for all purposes.

### BACKGROUND

1. Technical Field

The present invention relates to wireless communications and, more particularly, to frame or packet based communication networks utilized by consumers on customer premises.

2. Related Art

As computers become more and more cost effective for the every day consumer and for small businesses, such computers become more plentiful for use within local area environments such as homes, office buildings and the like. For example, within a home a person with a computer in the bedroom, and another in the living room, may want to share common files, utilize a common broadband modem such as a cable modem or digital subscriber line (DSL), or otherwise transfer information between the computers. Accordingly, various technologies are being developed for interconnection of multiple computers located within such environments. One example of such technologies is the Institute for Electrical and Electronic Engineers (IEEE) 802.11 wireless specifications for wireless local area network (LAN) computer interconnection which utilize wireless or radio waves within the local environment for the transmission of data packets between the computers. Other examples include Bluetooth and Ultra Wide Band (UWB).

Wireless home networking has emerged as a preferred technology for the distribution of data services within the home. With prices that are comparable to wired alternatives, and with the promise of connectivity throughout the home without wires, IEEE 802.11 is a natural choice for users of home networks.

One main contributing factor to the popularity of 802.11 technology is the availability of broadband connections to the home. Moreover, computers are becoming common products within the home to the extent that many homes include multiple computers. Thus, there is an ever-increasing demand for sharing of broadband connections within the home thereby further increasing a need for home networking.

The raw data rates of 802.11 wireless network systems of 54 megabits per second and transmission ranges in excess of 300 feet, offer a very good solution for the increasing need for home networking. As new services are introduced over the home network, follow on services and standards such as that provided by 802.1 In address the growing demand for capacity and high quality of service.

One problem, however, is that data reliability provided by the higher data rate wireless standards is lower due, in part, to the shorter signal length signals being transmitted throughout a house having many walls and furniture that provide interference to the signals. Thus, reliable delivery of services using higher data rate standard technologies cannot be guaranteed and further presents a problem requiring a solution.

For example, FIG. 1 illustrates a prior art home network. As maybe seen, a high frequency cable (HFC) signal source provides a high frequency cable signal to a radio frequency splitter that further provides the HFC signal to a wireless cable modem as well as to a television. A cable modem with wireless interface generates wireless data over a wireless link to one or more hosts. The wireless data comprises one of a high frequency cable signal or a data signal from another source or data generated by the wireless cable modem. As may further be seen, the home wireless network of FIG. 1 further includes a laptop host that is out of range of the cable modem with wireless interface. For example, if the wireless cable modem operates according to a wireless protocol such as 802.11, then a laptop host that includes a wireless card that operates according to 802.11 standards may have been moved to a room or location for which multi-path interference is too great to allow reliable signal delivery thereto. The HFC signal provided by the HFC signal source comprises any one of cable television signals, cable modem data signals, or a combination thereof.

### SUMMARY OF THE INVENTION

A method and an apparatus for splitting and combining television signals and other protocol signals such as home networking signals and cable modem signals that are propagating over a coaxial cable system includes a three port adapter and use thereof that allows a home cable wiring network for propagating television entertainment signals to further propagate home networking signals in a non-interfering manner. The three-port adapter separates wireless or RF data protocol signals from cable modem signals and entertainment signals such as cable television signals, that are all present on a first port, and communicates wireless or RF data protocol signals on a second port and cable modem and entertainment signals on a third port. Generally, two types of adapters are provided. The first type of adaptor is where the second port is wired to a remote device that communicates wireless protocol or other non-cable TV protocol. The second type of adaptor includes an antenna port as the second port and communicates wireless or RF data protocol signals over a wireless link with a remote host.

The first type of three-port adapter that is wired to a remote device for communicating with an wireless or RF data protocol has a first coax cable port, a second coax cable port and a third coax cable port. The second coax cable port is for splitting signal power between the first (or combining therefrom) coaxial port and the third coaxial port through a diplexer such as a ferrite bead splitter in one embodiment of the invention. A path is provided between the first coax port, the second coax port and the third coax port at frequencies propagating home networking communication signals. A path is also provided between the first coax port and the third coaxial port at television frequencies. Accordingly, the three-port adaptor communicates television and home networking communication signals over a coax cable. Effectively, the adaptor may be used to splice home networking signals onto a home coax network intended for cable or satellite television. The home networking communication signals are communicated through the second coax port of the adaptor to an external device over a communication link and television signals are communicated through the third coax port to a television. Moreover, as an additional aspect, the home network communication signals are also communicated through the third port in one embodiment.

The second type of adaptor, as mentioned above, is a wireless coax tap and includes an antenna port as a second port for transmitting and receiving wireless or RF data home networking signals to and from a remote host. Thus, received signals are spliced into the coax cabling within the dwelling and outgoing transmitted signals are extracted from the coax cabling. A number of the second type of adaptors may be connected throughout the dwelling or structure to provide communication links to wireless hosts that would not otherwise receive communication signals with tolerable error rates due to various multi-path interference sources.

As yet another aspect of the present invention, a plurality of the adaptors may be coupled in series. Thus, the television and home network communication signals are communicated to the television by way of a second three-port adaptor and wireless or RF data protocol signals are communicated through an antenna or coax port (if being conducted by coax) to an external device having capability for communicating by way of the wireless or RF data protocol.

For each of the types of adaptors having a first coax cable port, a second coax cable port (or antenna port) and a third coax cable port, the first coax cable port splitting power between the second coax port and the third coax port through a diplexer such as aferrite bead splitter, a path is provided between the first coax port and the second coax port at frequencies propagating home networking communication signals and a path is provided between the first coax port and the third coax port at television frequencies. Moreover, the three-port adaptor is operable to receive home networking communication signals over the second port and transmits home networking communication signals from the first coax port.

The adapters may be integrated into remote devices, cable modem devices, televisions and other devices connected to the coax network.

### BRIEF DESCRIPTION OF THE DRAWINGS

FIG. 1 shows in block diagram form a general home networking and entertainment environment according to the prior art;

FIG. 2 is a block diagram illustrating a general home network within which the present invention can be implemented;

FIG. 3 illustrates the spectral allocation over coax according to one embodiment of the present invention;

FIG. 4 is a block diagram of a plurality of wireless coax taps coupled either directly or indirectly to an access point according to one embodiment of the invention;

FIG. 5 is a schematic diagram of a wireless coax tap formed according to one embodiment of the invention;

FIG. 6 is a functional block diagram illustrating a network topology according to one embodiment of the present invention; and

FIG. 7 is a flow chart illustrating a method for conducting RF signals and wireline protocol signals over a coaxial cable according to one embodiment of the invention.

### DETAILED DESCRIPTION OF THE INVENTION

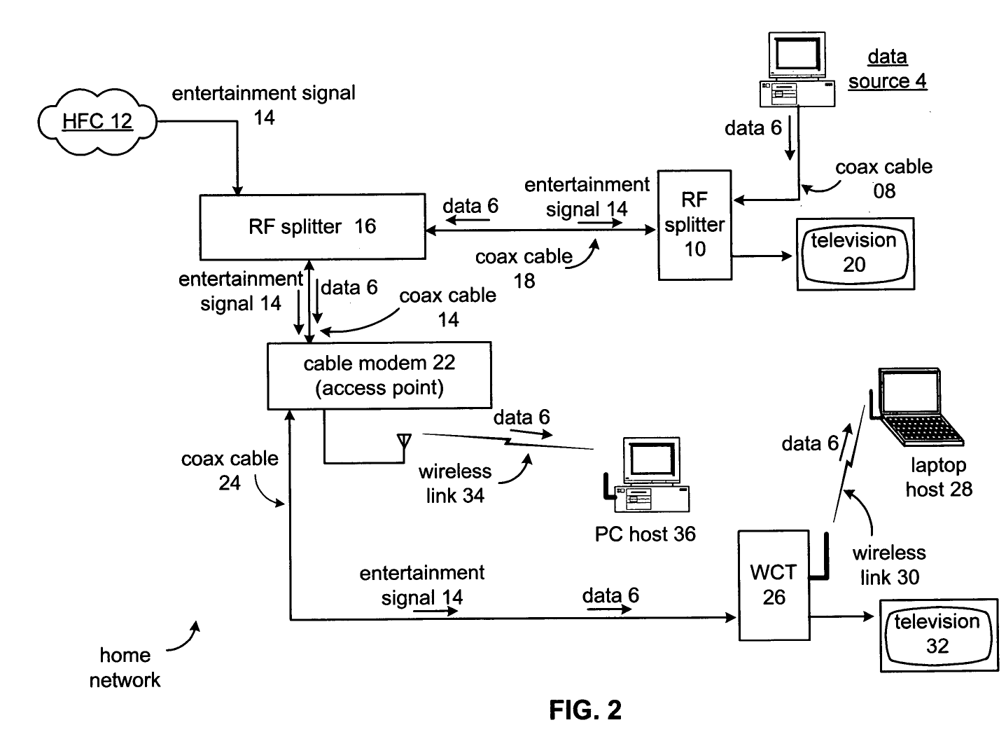

FIG. 2 is a block diagram illustrating a general home network within which the present invention can be implemented. The home network of FIG. 2 includes coaxial cable and one or more adapters for distributing cable television signals to televisions and other devices capable of receiving and processing television signals in any format or protocol including digital and analog, wireless 802.11 signals to wireless clients (hosts), and wireless and RF data signals to wired clients (hosts) according to one embodiment of the present invention.

More specifically, a data source 4 includes an 802.11 over coax card for generating 802.11 signals (data 6) over a coax cable 8. Coax cable 8 produces the 802.11 data 6 to an RF splitter 10. A high frequency cable (HFC) signal source 12 produces an entertainment signal 14 to an RF splitter 16. RF splitter 16 receives data 6 over a coax cable 18 from RF splitter 10 and produces entertainment signal 14 to RF splitter 10 that in turn produces entertainment signal 14 to a television 20. RF splitter 16 further combines the received signals (data 6 and entertainment signal 14) and produces 802.11 data 6 and entertainment signal 14 to a cable modem 22. Cable modem 22 is also known as an access point for the home network of FIG. 2. As may be seen, cable modem 22 produces data 6 and entertainment signal 14 over a coax cable 24 to a wireless coax tap (WCT) 26. WCT 26 includes an antenna for transmitting 802.11 signals, and more particularly, data 6 to a laptop host 28 over a wireless link 30. Cable modem 22 further includes an antenna for transmitting 802.11 signals, and more particularly, data 6 over a wireless link 34 to a personal computer (PC) host 36. In the example shown, cable modem 22, laptop host 28 and PC host 36 are part of a home network that may further include other wireless clients similar to laptop host 28 and PC host 36.

Referring again to FIG. 2, a laptop host such as laptop host 28 was not able to directly communicate with cable modem 22 because of, for example, multi-path interference without the extended range provided by WCT 26 and coax cable 24. Thus, while PC host 36 can connect directly to the access point or cable modem 22, client or laptop host 28 was not able to connect due to conditions such as interference and attenuation caused by structures and furniture within the dwelling. Of particular importance for residential networks, however, are systems that provide communication between computers as reliably and with as high a data rate as possible. Communication over a residential network is typically provided through frame-oriented link, media access and physical layer protocols and is expected to be provided in a reliable manner at an acceptable data rate (throughput rate).

Thus, referring again to FIG. 2, a method is shown to network communication devices such as a Set Top Box (STB) or Data Source 4 near a home's entertainment center (e.g., television) utilizing coaxial cable. Typically, a phone jack is not present at or near most home entertainment centers. It is normally too expensive or undesirable to add new wiring to provide a new phone jack. Likewise, an Ethernet LAN network connection is too costly and troublesome to provision for such home entertainment centers as opposed to its use in computer networking. Some cable television installers have used inexpensive high frequency (HF) band FM wireless modems to provide a simple, low bandwidth analog modem connection to the home entertainment system. This enables low-speed Internet access and pay-per-view services. These low speed wireless modem links are not suitable for high bandwidth, high quality video or Voice over IP (VoIP) services.

Other, higher bandwidth, wireless networking products such as those implementing the IEEE 802.11b specification and more recently the IEEE 802.11a and IEEE 802.11g specifications are available, but these products may suffer from poor link reliability over even fairly short transmission distances and typically cannot offer the low bit error rates necessary to carry digital video without significant interruption to the viewer as in the case of laptop host 28, above. However, at or very near almost every home entertainment center there is pre-wired coaxial cable (e.g., RG-6 or RG-59 coax) that feeds the cable television or TV antenna signal (e.g., satellite) to other rooms in the house. Typically, coax is installed to all the other likely entertainment locations in the house—the bedrooms, the study, the family room or lounge—making coax ideal for the delivery of high-speed digital content to exactly where it is desired. Thus, using the WCT 26 and the RF splitter 10 according to the present invention, the coaxial cabling in a house may be used to provide expanded range for wireless home networking applications for access points such as cable modem 22.

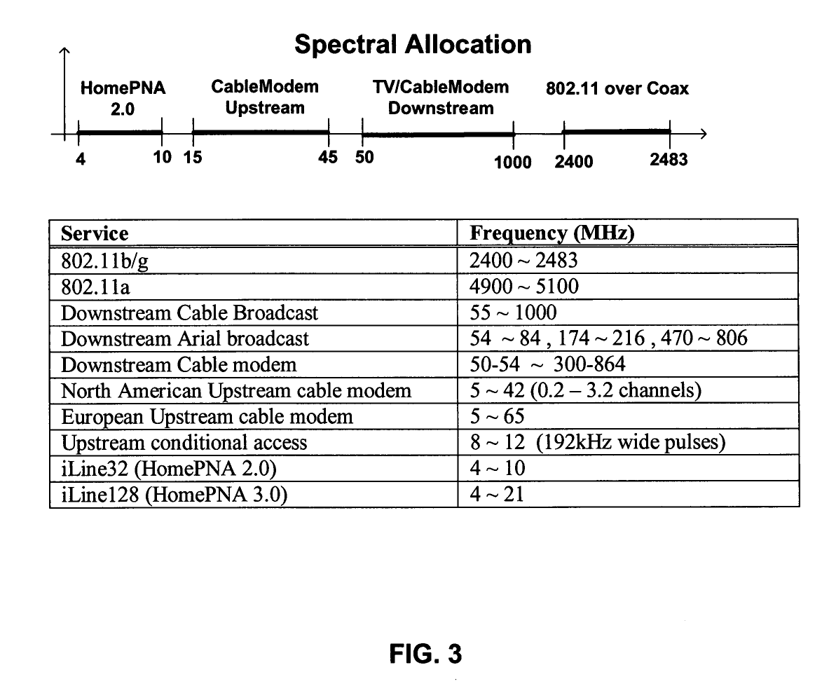

In addition to physical installation considerations, when designing home networks, another important consideration is spectral management. The coaxial cabling within a typical home is subject to several sources of ingress. In addition to the expected terrestrial broadcast and cable broadcast television signals, other intentional signals such as cable modems or set top box conditional access signals may be present. Examples of the several signals of services and frequencies that may be present on household coaxial cable and may interfere with each other are shown in FIG. 3. Additionally, there are some unintentional noise sources on the household coaxial cable. Older built-in TV tuners can generate significant amounts of intermediate frequency (IF) egress out of their antenna/cable TV F-connectors.

While it is well known in the art that splitters, RG-6 and RG-59 cables are suitable for carrying cable televisions signals, splitters such as RF splitter 10 of FIG. 2, RG-6 and RG-59 cables are also suitable for carrying signals in the 2.4 to 5.8 GHz spectrum for short distances.

The extrapolated losses for RG-6 cable are:

@2.4 GHz=12 dB/100 feet

@5.8 GHz=28.5 dB/100 feet

The standard cable TV splitter has 4 dB insertion loss and 27 dB output port isolation at 1 GHz which are extrapolated to 2.4 and 5 GHz.

Thus, a typical house, with three splitters cascaded from the cable TV access point to provide 4 TV set outlets, each one about 100 feet from the “top” splitter, will have the following losses between two of the end nodes (two lots of cable loss, two lots of splitter loss, and one lot of isolation attenuation due to the top of the tree splitter):

@2.4 GHz=12+12+4+4+27=59 dB

@5.8 GHz=28.5+28.5+4+4+27=89 dB

Thus, assuming the typical +15 dBm at the transmitter output, the receivers will see:

@2.4 GHz=−69+15=−44 dBm

@5.8 GHz=−89+15=−74 dBm

−44 dBM is well within the typical operating range of 802.11b/g receivers. Since 802.11a receivers typically need an RX level of about −67 dbm to work at 54 Mbps, the cable plant must be shortened.

Considering RG-59 cable, which is much lossier, the extrapolated loss is:

@2.4 GHz=17.5 dB/100 feet

@5.8 GHz=41 dB/100 feet

Thus, the receive power would be:

@2.4 GHz=−70+15=−55 dBm

@5.8 GHz=−117+15=−102 dBm

802.11b/g will work suitably with RG-59 cable in “most houses”, but 802.11a will not work as well in a house in which the cable length is too long. The maximum distance of RG-59 cable that could be supported by 802.11a in the typical setup is:

(67−15−4−4−27)/0.41=41.5 feet

In most network setups, the connection speed between the two end nodes is relatively unimportant (since these two machines are only likely to be doing file sharing and other simple peer-to-peer things). The large bandwidth pipe (for HDTV or DVD video and such) is only needed between the top of the splitter tree and each end node. The losses in this case are much less. In these connections, the typical receive powers are:

RG-6 @ 2.4 GHz=15−12−4−4=−5 dBm

RG-6 @ 5.8 GHz=15−28.5−4−4=−21.5 dBm

RG-59 @ 2.4 GHz=15—17.5−4−4=−10.5 dBm

RG-59 @ 5.8 GHz=15−41−4−4=−34 dBm

Thus, 802.11a or 802.11b/g will work suitably from the cable modem/set-top box to each end node, using either RG-6 or RG-59 cable.

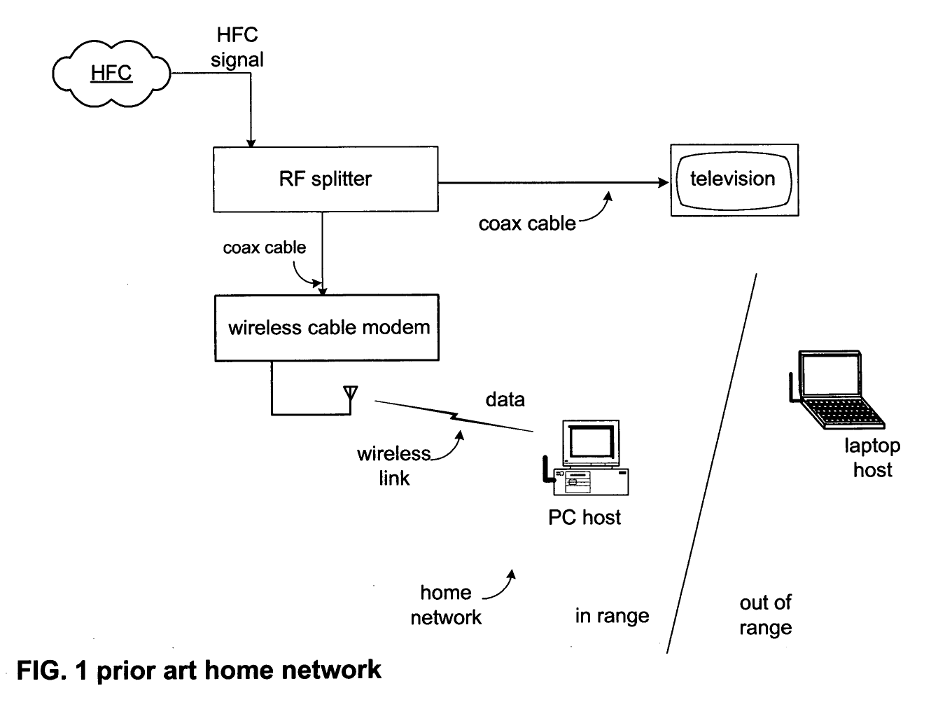

Given the home networking and entertainment distribution system depicted in FIG. 1, and the desirability that the home networking system including wireless technologies be interconnected to pre-existing coaxial cable system(s) within the home, such as one connecting cable TV, and the desirability of appropriately managing the spectrum on the coaxial cable network, a need therefore exists for a system, method and apparatus for transporting home networking packet-based communications signals over coaxial cables.

In the embodiment of the present invention of FIG. 2, a method and apparatus is provided for coupling a system propagating wireless home networking communication signals to a system propagating television signals over a coaxial cable system to a television device. More particularly, a cable network that carries cable television signals as well as 802.11 data signals as shown in FIG. 1 further includes an apparatus for delivering 802.11 wireless signals to a remote wireless client that would not otherwise receive the wireless signals due to interference or attenuation. More particularly, FIG. 2 shows the network of FIG. 1 further including a three-port adapter, in one embodiment, referred to as a wireless coax tap (WCT) 26. WCT 26 has an antenna port, a first coaxial cable port coupled to coax cable 24 and a second coaxial cable port in the described embodiment coupled to a television 32. The first coaxial cable port of WCT 26 is internally coupled to the antenna port to pass wireless home networking communication signals (e.g., data 6) over wireless link 30. The first coaxial cable port is also coupled to the second coaxial port to pass cable television signals (e.g., entertainment signal 14), cable modem, and the home networking communication signals (where undesired signals may be filtered).

In another embodiment of the present invention, a method and apparatus for splitting television and networking signals propagating over a coaxial cable system is provided. A three-port RF splitter 10 has a first coaxial cable port, a second coaxial cable port and a third coaxial cable port. The first coaxial cable port splits power between the second coaxial cable port and the third coaxial cable port through a diplexer such as a ferrite bead splitter. The first coaxial cable port, the second coaxial cable port and the third coaxial cable port are coupled to each other and are adapted to provide a low loss path there between at frequencies propagating home networking communication signals. The second coaxial cable port passes cable television signals directly to television 20. The third coaxial cable port passes networking signals to a device with home networking capabilities. The second coaxial cable port may comprise coupling hardware for coupling to one of a coax cable or an antenna according to whether it is being connected as shown for RF splitter 10 or as WCT 26.

As will become readily apparent in view of the detailed description set forth below, network communication utilizing IEEE 802.11 11 Mbit/s or 54 Mbit/s home networking communication signal technology sharing a home's existing coaxial cable provides high-speed networking for delivery of high quality digital video, voice over IP (VoIP) and shared broadband Internet access throughout the house without adding any new wires. IEEE 802.11 can be added to the existing coaxial cable and be totally compatible with the existing cable TV or off-air TV signals. Additionally, IEEE 802.11 nodes are relatively inexpensive. Further, as more bandwidth is required, future wireless standards that provide approximately 100 Mbit/s could be employed over exactly the same network infrastructure, offering a simple upgrade path for future services such as high definition television. FIG. 3 illustrates the spectral allocation over coax according to one embodiment of the invention.

Continuing to refer to FIG. 2, data source 4, as well as hosts 28 and 36 can transmit and receive data in accordance with the 802.11 protocol at the same time. Television 20 is interconnected over a coaxial cable transmission medium to coax cable 8 that carries these 802.11 protocol home networking signals.

As the home entertainment market moves towards high bandwidth broadband digital media delivery, digital distribution of that media content within the home becomes essential. With the broadband access point at the home entertainment center via cable modem 22 and with an in-home network emanating from that point, it becomes possible to provide high-quality digital streaming video, VoIP and Internet access services throughout the home. In accordance with the present invention, a simple way is provided to transport digital media using 802.11 traffic over 75 Ω coaxial cable, in addition to wireless distribution as described above. Moreover, this may be accomplished in a network that may already exist (cable network) in a home in a manner wherein 802.11 communication traffic can coexist on the house's existing coaxial cable and provide high quality service to all nodes on most coaxial cable installations. RF splitter 10 and WCT 26 splice the 802.11 signal into and out of the coaxial cable, e.g., RG-6/59. The 802.11 signal is therefore able to coexist on the coaxial cable with most existing cable TV or off-air TV transmissions.

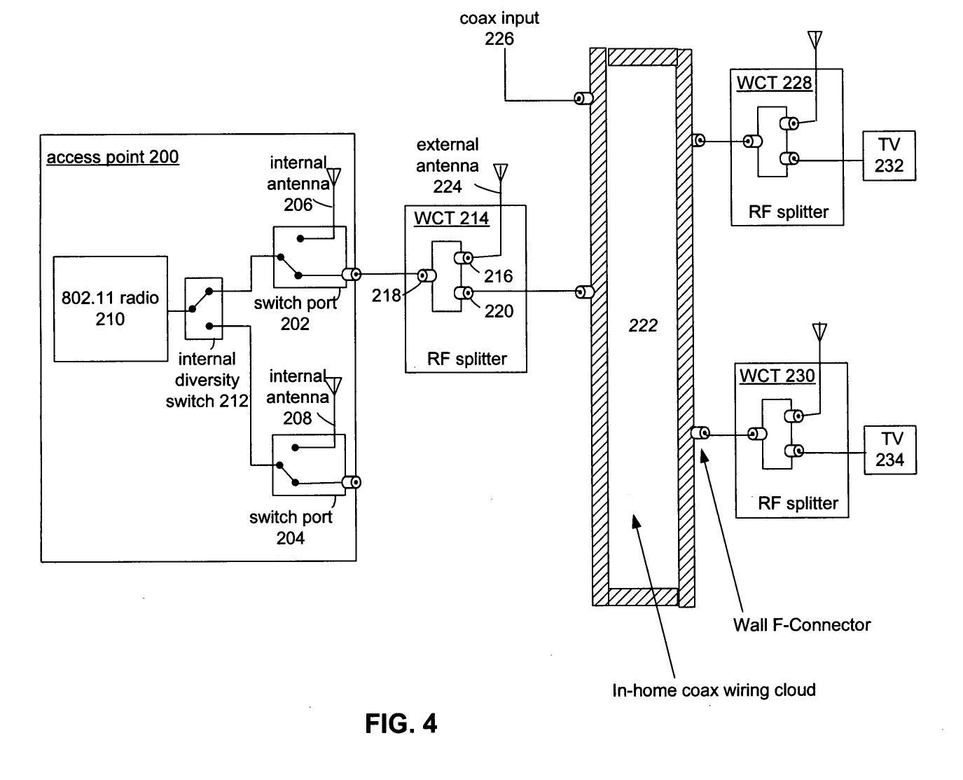

FIG. 4 is a block diagram of a plurality of wireless coax taps coupled either directly or indirectly to an access point according to one embodiment of the invention. Referring now to FIG. 4, a WCT is shown in block diagram form as coupled directly to an access point 200 and, more specifically, to an antenna jack of a switch port of access point 200. Each switch port shown, and more specifically switch ports 202 and 204, includes an internal switch for coupling one of a jack or an internal antenna 206 and 208, respectively, to a radio 210. In the described embodiment, the switch ports are selectively (mutually exclusively) coupled to radio 210 (either directly or by way of an internal diversity switch 212. A WCT 214 is used to splice an 802.11 signal onto the coaxial cable. WCT 214 is a simple passive three-port diplexer device. WCT 214 includes antenna port 216, Coax (to wall)-‘F’ type RF connector port 218, and TV-‘F’ type RF connector port 220.

Access point 200 typically contains an 802.11 radio 210. The output of the 802.11 radio is typically connected to internal antennas 206 and 208 through an internal diversity switch 212 used to switch between the antennas for optimizing reception. Switch port 202 is inserted in the circuit to allow an external antenna to be connected to access point 200. A WCT is connected to port 202 bypassing internal antenna 206 to distribute the 802.11 signal both over a coax wiring cloud 222 and air via external antenna 224. In the described embodiment, radio 210 is an 802.11b radio. In alternate embodiments, radio 210 comprises one of an 802.11a, 802.11 g, Bluetooth or other wireless local or personal area network radio technology. As may further be seen in FIG. 4, a pair of WCTs 228 and 230 are each coupled to wiring cloud 222 to radiate and receive 802.11 signals to a wireless host (not shown herein in FIG. 4) such as hosts 28 and 36 of FIG. 2, as well as to produce cable television signals to televisions 232 and 234. Wiring cloud 222 is further coupled to receive an entertainment signal (e.g., entertainment signal 14 of FIG. 4) from any one of a cable TV signal source, a satellite TV signal receiver, or other source at coax input 226.

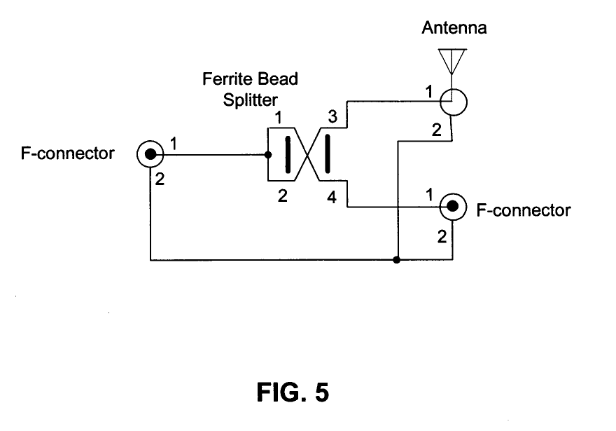

FIG. 5 is a schematic diagram of a wireless coax tap formed according to one embodiment of the invention. For example, WCT 214 as shown in FIG. 4 is shown in more detail schematically in FIG. 5. Those skilled in the art can appreciate that the circuit and component values may be adjusted for circuit optimization and that there could be variations or equivalent embodiments that implement the present invention. For example, while the present embodiments depict an adapter (WCT) as a physically separate unit with one of the ports being an antenna, those skilled in the art might envision devices having an embedded adapter with just one physical coaxial port wherein the signal connects directly (internally) to the 802.11 transceiver without ever transiting on a coaxial cable or wireless link.

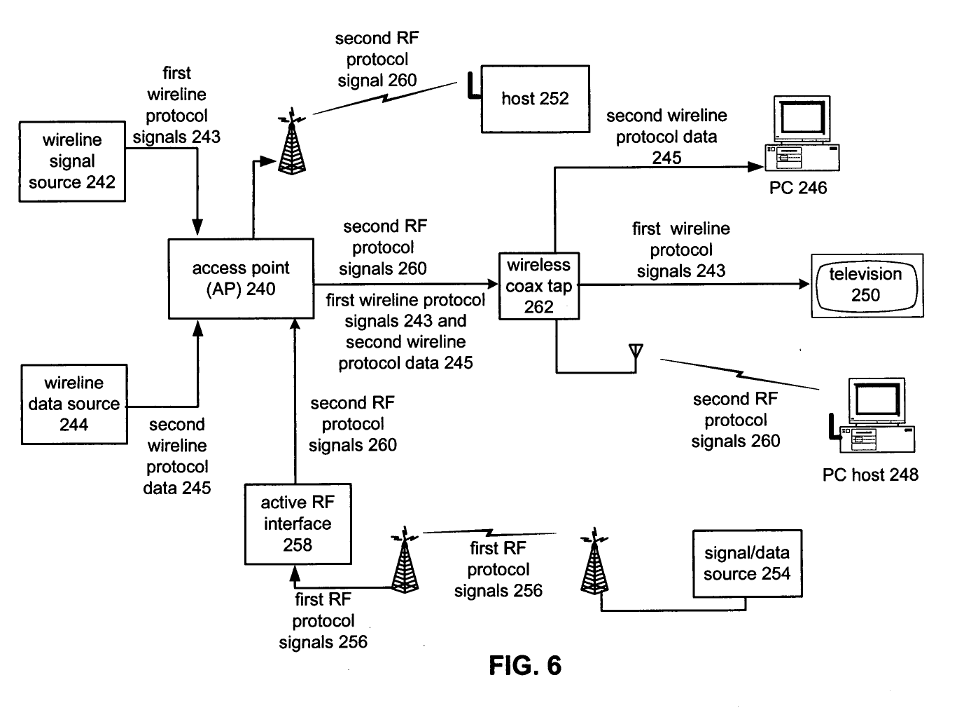

FIG. 6 is a functional block diagram illustrating a network topology according to one embodiment of the present invention. Referring now to FIG. 6, an access point 240 is coupled by way of wireline and wireless links to receive a plurality of communication signals transmitted according to wireless and wireline protocols. In the specific example of FIG. 6, communication flows from sources coupled to the access point 240 to at least one of a plurality of destinations by way of a wireless coax tap or directly by a wireless link. It is understood that communications also flow in the opposite direction. Here, only one direction is shown for simplicity.

As may be seen therefore, access point 240 is coupled to receive communication signals from at least one destination from wireline signal and data sources 242 and 244, respectively. Access point 240 then produces the received communication signals to a plurality of destinations as will be described in greater detail below. Here, wireline signal source 242 is an entertainment receiver device such as a cable box or a satellite receiver and produces first wireline protocol signals 243. Wireline data source 244, however, is a data device and produces second wireline protocol data 245. By way of example, wireline data source 244 may comprise a compact disk drive, a DSL modem, a computer, etc. for generating data for transmission to another data device such as a PC 246 or a wireless PC host 248. Wireline signal source 242, in the present example, generates signals for delivery to a television 250. Other entertainment devices may also be coupled in place of television 250. For example, an amplifier for playing music may be coupled thereto. Finally, as may be seen, access point 240 may also generate communication signals for wireless transmission directly to a host 252.

As may also be seen, a signal/data source 254 generates wireless communication signals 256 for transmission according to a first wireless protocol. An active wireless interface device 258 receives the first wireless protocol signals 256 and converts them to second wireless protocol signals 260. In the described embodiment, second wireless protocol signals 260 are one of 802.11(a) or 802.11(b/g) protocol signals transmitted in the spectrum of approximately 5.0 or 2.4 GHz, respectively. First wireless protocol signals 256 are transmitted according to an wireless protocol other than second wireless protocol. For example, first wireless protocol signals 256 may be transmitted according to an established cellular protocol and frequency (e.g., CDMA, GSM, North American TDMA, AMPS, etc.). Alternatively, first protocol signals may be transmitted according to a commercial signal delivery protocol such as that used by any of the commercially available satellite receivers. Alternatively, first protocol signals may be transmitted according to one 802.11 protocol and the second protocol signals may be a different 802.11 protocol or the same 802.11 protocol using a different channel.

Active wireless interface 258 generates second wireless protocol signals 260 to access point 240. Access point 240, in the described embodiment, generates the second wireless protocol signals over a wireless transmission medium by way of an internally formed wireless transmitter (not shown). Access point 240 further generates second wireless protocol signals 260 over a coaxial cable to a wireless coax tap (WCT) 262 in addition to transmitting first wireline protocol signals 243 and second wireline protocol data 245 for transmission to at least one of PC 246 and PC host 248. In the prior described embodiment, an access point generated cable television signals for delivery to a television, as well as 802.11 RF signals for radiation by a three tap wireless coax tap for delivery to a wireless host.

More specifically, WCT 262 receives each of the signals and separates the received signals for transmission. For example, WCT 262 transmits first wireline protocol signals 243 to television 250, second wireline protocol data 245 to PC 246, and second wireless protocol signals 260 to PC host 248 over a wireless communication link. In the described embodiment, the second wireless protocol signals 260 are separated from WCT 262 while the first wireline protocol signals 243 and the second wireline protocol data 245 are not separated at the WCT 262. Filters within television 250 and PC 246 extract only the desired signals. In an alternate embodiment, however, WCT 262 includes the necessary filters/splitters to divide out each protocol signal to its respective port.

In the example of FIG. 6, a four-tap wireless coax tap is utilized to facilitate delivery to two wireline destination devices, each operating by a different communication protocol as well as for delivery of wireless communication signals transmitted by way of a wireless protocol. In one embodiment of the invention, the wireless protocol is one of 802.11 (a), 802.11 (b), Bluetooth or other WLAN or WPAN protocol. One wireline protocol is that utilized by cable televisions (CATV). A second wireline protocol is a data protocol, for example, a personal computer communication protocol. Moreover, as described earlier, the communication signals transmitted to PC 246 may also be 802.11 protocol signals even though being transmitted over a wireline medium (here, coax cable). Thus, the wireless coax tap 262 of FIG. 6 supports simultaneous transmission of wireless protocol signals over wired and wireless communication mediums in addition to two other wireline communication protocols.

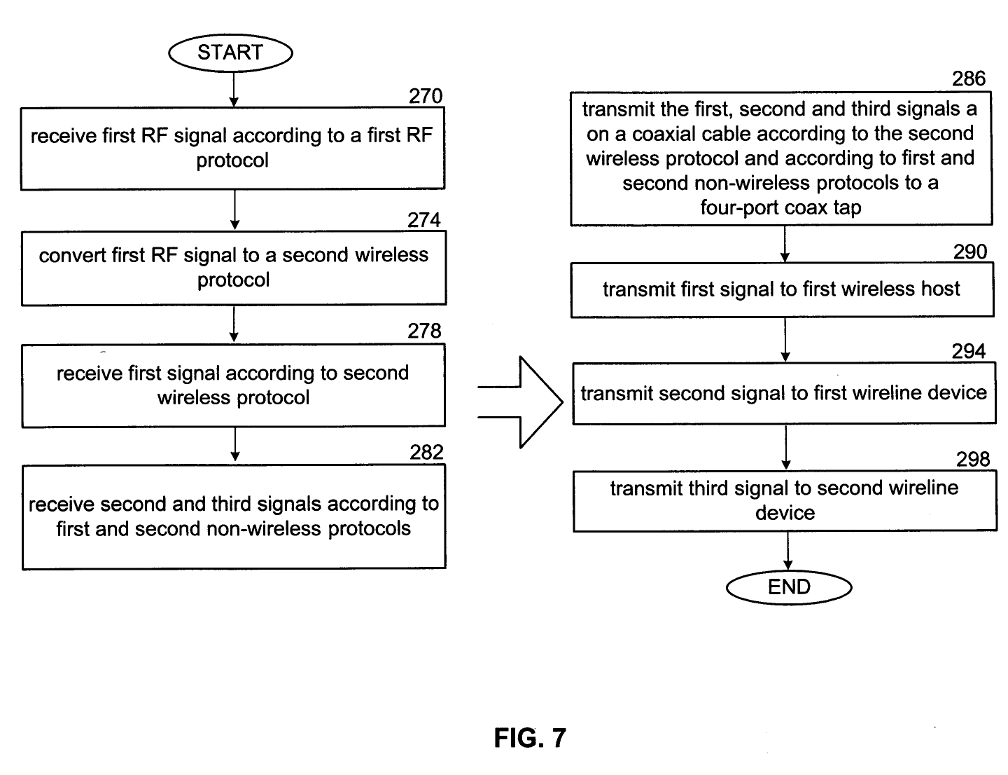

FIG. 7 is a flow chart illustrating a method for conducting wireless protocol signals and wireline protocol signals over a coaxial cable according to one embodiment of the invention. More specifically, a first module receives a first RF signal according to a first wireless protocol (step 270). Thereafter, the first module converts the first RF signal to a second wireless protocol (step 274). A second module then receives the first signal according to a second wireless protocol from the first module (step 278). The second module further receives a second signal and a third signal according to first and second non-wireless protocols (step 282). The second module then transmits the first, second and third signals over a coax cable to a four-port wireless coax tap (step 286). The wireless coax tap then transmits the first signal to a first wireless host (step 290), the second signal to a first wireline device (step 294), and the third signal to a second wireline device (step 298). In the described embodiment of the invention, the wireless coax tap comprises filtration circuitry to pass a corresponding signal and block all other signals at each of the three ports used as output ports.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention. Those skilled in the art can appreciate, for example, that the invention could be applied to other wireless technologies such as Bluetooth, code division multiple access (CDMA), global system for mobile communications (GSM), etc.

What is claimed is:

1. A method for coupling a system propagating wireless protocol home networking communication signals over wireless to a system propagating television signals over a coaxial cable system to a device capable of receiving and processing television signals in any television signal protocol or format, comprising:
providing a three-port adapter, the three-port adapter having an antenna port, a first coaxial cable port and a second coaxial cable port, the first coaxial cable port:
being coupled to the antenna port to pass home networking communications signals, and
being coupled to the second coaxial cable port to pass home networking and entertainment communication signals;
coupling the antenna port to the system propagating home networking communication signals;
coupling the first coaxial cable port to the system propagating television signals over the coaxial cable system; and
coupling the second coaxial cable port to the device capable of receiving television signals by one of a wired or wireless medium.

2. The method of claim 1 wherein the three-port adaptor comprises a wireless coax tap and wherein the first coaxial cable port communicates television and home networking communication signals over a coax cable.

3. The method of claim 2 wherein home networking communication signals are communicated through the antenna port to an external device over a wireless communication link and television signals are communicated through the second coaxial cable port to a device capable of receiving television signals.

4. The method of claim 3 wherein home network communication signals are also communicated through the second coaxial cable port.

5. The method of claim 4 wherein the television and home network communication signals are communicated to the device capable of receiving television signals by way of a second three-port adaptor.

6. The method of claim 5 wherein the second three-port adaptor comprises a wireless coax tap.

7. A method for splitting television signals propagating over a coaxial cable system comprising:
providing a three-port adapter, the three-port adapter having a first coaxial cable port, a second coaxial cable port and a third coaxial cable port, the first coaxial cable port splitting power between the second coaxial cable port and the third coaxial cable port through a diplexer;
wherein, a path is provided between the first coaxial cable port, the second coaxial cable port and the third coaxial cable port at frequencies propagating home networking communication signals; and
wherein a path is provided between the second coaxial cable port and the third coaxial cable port at television frequencies.

8. The method of claim 7 wherein the first coaxial cable port communicates television and home networking communication signals over a coax cable.

9. The method of claim 8 wherein home networking communication signals are communicated through the second coaxial cable port to an external device over a communication link and television signals are communicated through the third coaxial cable port to a device capable of receiving television signals.

10. The method of claim 9 wherein home network communication signals are also communicated through the third coaxial cable port.

11. The method of claim 10 wherein the television and home network communication signals are communicated to the television by way of a second three-port adaptor.

12. The method of claim 11 wherein the second three-port adaptor comprises a wireless coax tap.

13. A splitter apparatus for splitting television signals propagating over a coax cable system comprising:
a three-port adapter, the three-port adapter having a first coaxial cable port, a second coaxial cable port and a third coaxial cable port, the first coaxial cable port splitting power between the second coaxial cable port and the third coaxial cable port through a diplexer, wherein:
a path is provided between the first coaxial cable port and the second coaxial cable port at frequencies propagating home networking communication signals; and
a path is provided between the first coaxial cable port and the third coaxial cable port at television frequencies.

14. The splitter of claim 13 wherein the three-port adaptor receives television signals over the first coaxial cable port and transmits home networking communication signals from the third coaxial cable port.

15. The splitter of claim 13 wherein the three-port adaptor receives home networking communication signals over the second coaxial cable port and transmits home networking communication signals from the first coaxial cable port.

16. The splitter of claim 14 wherein the three-port adaptor receives home networking communication signals over the first coaxial cable port and transmits home networking communication signals from the second coaxial cable port.

17. A splitter, comprising:
coax input port for communicating communication signals generated with a plurality of communication protocols by a plurality of communication signal sources;
first coax output port for producing a wireline communication signal according to a wireline protocol to a wireline device;
second output port coupled to an antenna for receiving and radiating wireless communication signals according to an wireless communication protocol.

18. The splitter of claim 17 further comprising a third output port for producing a second wireline communication protocol signal to a second wireline device wherein the coax input port receives communication signals according to at least one wireless communication protocol and communication signals according to at least two wireline communication protocols.

19. A home network, comprising:
input coax coupled to receive at least one of a television signal and a data signal originating from a data packet network;
three-port adaptor coupled to the input coax on a first port, to coax wiring within a dwelling on a second port and to a communication device that communicates over a wireless protocol on a third port; and
wherein television signals received on the first port coupled to the input coax are produced to the coax wiring within the dwelling over the second port and wherein wireless protocol signals received on the third port are produced on at least one of the first and second ports.

20. The home network of claim 19 further comprising a wireless coax tap coupled to one of the coax wiring within the dwelling that is further coupled to the second port or to the third port, wherein the wireless coax tap includes an antenna port for wireless RF communications with a host device.
